(19) United States
(12) Patent Application Publication
(10) Pub. No.: US 2009/0228658 A1
(43) Pub. Date: Sep. 10, 2009

(54) MANAGEMENT METHOD FOR CACHE MEMORY, STORAGE APPARATUS, AND COMPUTER SYSTEM

(76) Inventors: Takayuki NAGAI, Yokohama (JP); Masayuki Yamamoto, Sagamihara (JP); Masayasu Asano, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/468,463

(22) Filed: May 19, 2009

Related U.S. Application Data
(63) Continuation of application No. 10/960,056, filed on Oct. 8, 2004, now abandoned.

(30) Foreign Application Priority Data
Aug. 9, 2004 (JP) 2004-231793

(51) Int. Cl. G06F 12/08; G06F 12/00; G06F 12/02

(52) U.S. Cl. 711/129; 711/170; 711/162; 711/118; 711/E12.001; 711/E12.002; 711/E12.041

(57) ABSTRACT

A management method for a cache memory of a storage apparatus including: at least one volume for storing data to be accessed from a computer via a network; and a cache memory, to which an area for holding the data to be stored in said at least one volume is allocated for every said at least one volume, including the steps of: referring to a relation between predetermined volumes; and allocating an area, in which the data to be stored in a volume are held, to said volume on the basis of the relation between said volumes.

### CROSS-REFERENCES TO RELATED APPLICATIONS

This is a continuation of U.S. application Ser. No. 10/960,056, filed Oct. 8, 2004. This application relates to and claims priority from Japanese Patent Application No. 2004-231793, filed on Aug. 9, 2004. The entirety of the contents and subject matter of all of the above is incorporated herein by reference.

### BACKGROUND OF THE INVENTION

The present invention relates in general to a storage apparatus to be used in a computer system. More particularly, the present invention relates to a management method for a cache memory that is divided among disk volumes in the storage apparatus.

Generally, a computer system is configured of a host computer for performing individual businesses, and a storage apparatus that is commanded by the host computer to read/write data. The storage apparatus typically includes a plurality of magnetic disks for storing and reading data and a cache memory. When the host computer requests certain data, the storage apparatus examines whether or not the requested data is available in the cache memory, and, if so, it transfers the requested data from the cache memory to the host computer. If the requested data is not available in the cache memory, it makes access to the magnetic disks to obtain the requested data and stores the data temporarily in the cache memory, before it transfers the data to the host computer.

In this computer system, if a plurality of business data is to be consolidated in one storage apparatus, the different businesses will share the cache memory. As a result, if plural accesses are concentrated at one business so as to occupy much of the cache memory area, there may arise a problem in that the disk access performance of the other businesses drops. Especially as this technology has improved in recent years, the data storage capacity of the storage apparatus has increased year by year. It is a prominent tendency for data which has been managed separately for individual businesses in different storage apparatuses to be consolidated in and managed by one storage apparatus, with a view toward making the data management convenient. This tendency is liable to cause the aforementioned problem.

As a method for preventing an interference in the access performance between businesses, therefore, JP-A-5-128002 has disclosed a method by which a disk controller divides the cache memory and allocates the divided cache areas respectively to the individual businesses, for example. These divided cache areas will be called herein a “CLPR” (Cache Logical Partition). By allocating different CLPRs to respective ones of the individual business data, the disk access of one business can be prevented from occupying a majority of the cache memory, thereby to enhance the independence of the disk access performance of the individual businesses. Further, it is possible for the storage administrator to refer to and change the configuration of the CLPR assignments and the corresponding relation between the volumes and the CLPR areas by making use of a configuration management program which acts through the management server that is connected with the storage apparatus via a network.

However, if functions to correlate a plurality of disk volumes, such as copying functions or a concatenating function of the disk volumes, as provided by the storage apparatus, are applied to two disk volumes allocated to different CLPRs, the independence of performance achieved by using different CLPRs may be deteriorated.

Here a case will be considered in which business data, for example, is to be copied by using a disk volume copying function. The disk volume (or logical volume) will be simply called a “volume”. When the administrator creates a copy pair by selecting a copy source volume (or primary volume) for storing the business data or an unused copy source volume (or secondary volume), the data written from the host computer in the primary volume is copied, after the copy pair was created, to the secondary volume too, by the volume copying function. When the data is to be copied to the secondary volume, the cache memory of the secondary volume is used. As the amount of data written in the primary volume increases, therefore, the cache used by the secondary volume also increases. At this time, the independence of performance between the businesses is deteriorated if the secondary volume shares the CLPR area with other business data.

In the case of using a disk volume concatenating function to concatenate a plurality of disk volumes to show one disk volume to the host computer, the independence of performance between the businesses is also deteriorated, as in the copying function, if the disk volumes to be concatenated share the CLPR area with other business data. It is necessary to prevent an unintended performance interference between businesses, as might otherwise be caused by applying such functions as to correlate the plural disk volumes.

### SUMMARY OF THE INVENTION

In order to solve at least one of the problems thus far described, according to one aspect of the invention, there is provided a management method for a cache memory of a storage apparatus including: at least one volume for storing data; and a cache memory, to which an area for holding the data to be stored in the one volume is allocated for every volume, comprising the steps of: referring to a relation between predetermined volumes; and allocating an area, in which the data to be stored in a volume is held, to the volume on the basis of the relation between the volumes.

Incidentally, other aspects of the invention will become apparent from the following description provided in this specification and the accompanying drawings.

### BRIEF DESCRIPTION OF THE DRAWINGS

FIG. 1 is a block diagram showing an example of a computer system representing an embodiment of the invention;

FIG. 2 is a diagram showing the detailed configuration of an example of the storage apparatus provided in the embodiment of the invention;

FIG. 3 is a diagram showing the detailed configuration of an example of the management server provided in the embodiment of the invention;

FIG. 4 is a diagram showing an example of the configuration of a CLPR management table owned by the storage apparatus in the embodiment of the invention;

FIG. 5 is a diagram showing an example of the configuration of a volume management table owned by the storage apparatus in the embodiment of the invention;

FIG. 6 is a diagram showing an example of the configuration of a copy pair management table owned by the storage apparatus in the embodiment of the invention;

FIG. 7 is a diagram showing an example of the configuration of a concatenated volume management table owned by the storage apparatus in the embodiment of the invention;

FIG. 8 is a flow chart showing one example of the entire process flow of a volume copy pair creating routine to be executed by the management server in Embodiment 1;

FIG. 9 is a diagram showing an example of a screen displayed by the management server in Embodiment 1;

FIG. 10 is a flow chart showing one example of the entire process flow of a concatenated volume creating routine to be executed by the management server in Embodiment 1;

FIG. 11 is a diagram showing the detailed configuration of an example of a host in accordance with the invention;

FIG. 12 is a diagram showing an example of the configuration of a Priority management table owned by the management server in accordance with the invention;

FIG. 13 is a flow chart showing one example of the entire process flow of a volume copy pair creating routine to be executed by the management server in Embodiment 2;

FIG. 14 is a flow chart showing one example of the entire process flow of a volume copy pair releasing routine to be executed by the management server in Embodiment 2;

FIG. 15A is a flow chart showing one example of the entire process flow of a concatenated volume creating routine to be executed by the management server in Embodiment 3;

FIG. 15B is a flow chart showing the example of a continuation of the process flow of the concatenated volume creating routine to be executed by the management server in Embodiment 3;

FIG. 16 is a diagram showing one example of the screen to be displayed by the management server in Embodiment 3;

FIG. 17 is a diagram showing one example of the screen to be displayed by the management server in Embodiment 3; and

FIG. 18 is a diagram showing an example of the configuration of volumes, CLPRs and hosts.

### DESCRIPTION OF THE PREFERRED EMBODIMENTS

Various embodiments of the present invention will be described with reference to the accompanying drawings.

### Embodiment 1

Embodiment 1 will be described with reference to a method for re-evaluating the performance of a CLPR and displaying the evaluation result when a storage administrator creates a volume copy pair or a concatenated volume.

### (1) System Configuration

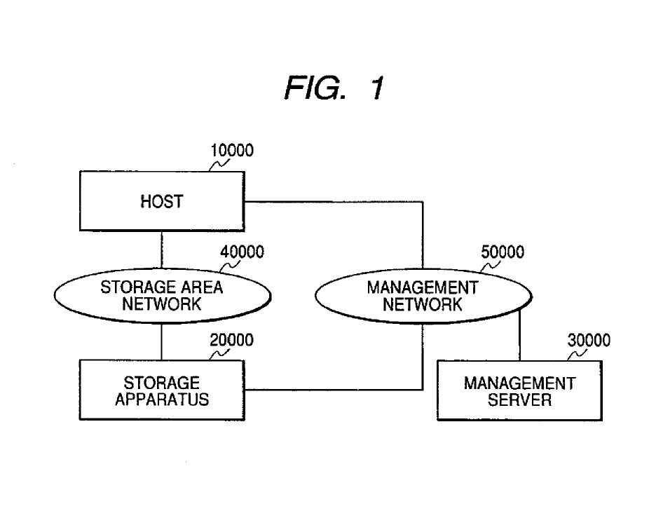

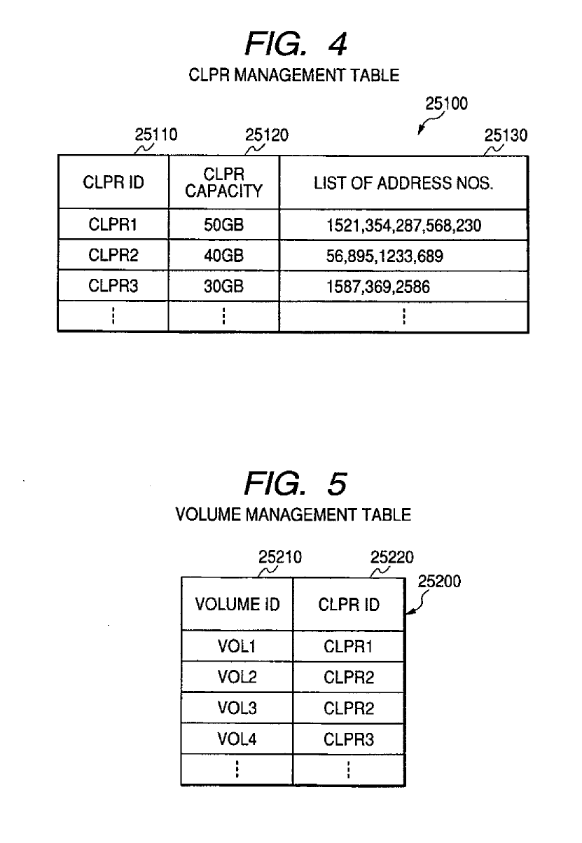

The configuration of a computer system will be described in connection with Embodiment 1. FIG. 1 to FIG. 3 show the configuration of the computer system and the configurations of devices to be connected with the computer system. FIG. 4 to FIG. 7 show items of management information to be owned by the individual devices.

FIG. 1 shows the configuration of the computer system. A storage apparatus 20000 and a host computer 10000 are connected via a storage network 40000. The storage apparatus 20000 is further connected with a management server 30000 via a management network 50000. Here, the storage network 40000 and the management network 50000 may be the same network. A plurality of storage apparatuses 20000 may also be provided.

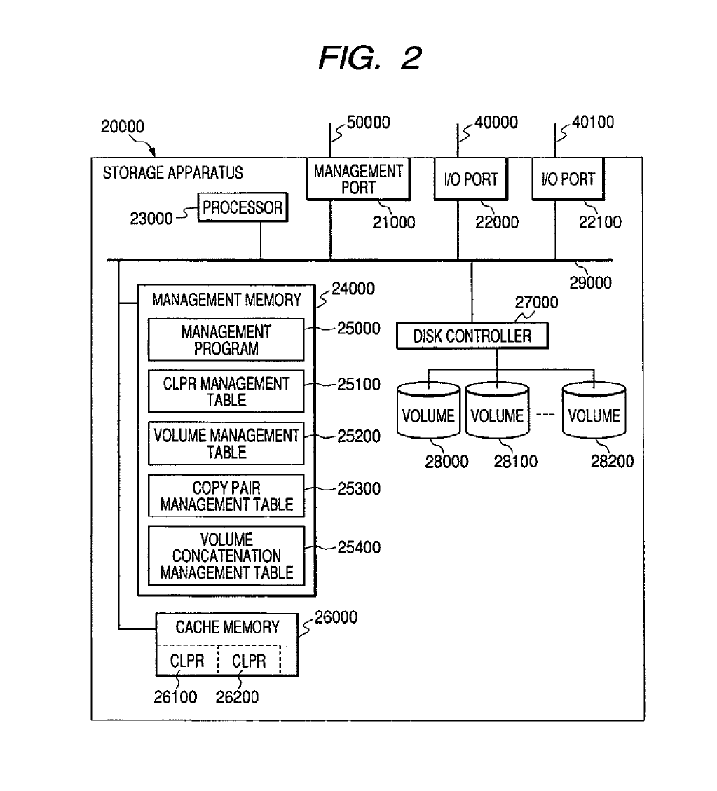

FIG. 2 shows an example of the storage apparatus 20000. This storage apparatus 20000 is provided with: a management port 21000 for connections with the management network 50000; an I/O port 22000 for connections with the host via the storage network 40000; a processor 23000 for controlling the storage apparatus; a management memory 24000 to be used by the processor; a disk volume 28000 for storing data to be supplied to the host computer; and a cache memory 26000 for storing the data. These components are connected with each other through a circuit 29000, such as an internal bus. The reading and writing of data from and in the individual volumes are controlled by a disk controller 27000. The management memory 24000 stores a management program 25000 of the storage apparatus. The processor 23000 reads the program and data stored in the management memory 24000 and processes the program.

The management program 25000 is configured of a cache division module, a volume copy module and a volume concatenation module. The cache division module divides the cache memory 26000 logically into a plurality of partitions (CLPR) 26100. The volume copy module creates a copy pair of a primary volume and a secondary volume, and it makes the contents of the primary and secondary volumes identical to each other. In other words, the secondary volume stores data representing a copy of the data of the primary volume. Each copy pair has two statuses “Pair” and “Split”. In the Pair status, the contents of the secondary volume are updated so as to be identical to those of the primary volume. In short, the performances of the primary volume and the secondary volume interfere with each other. In the Split status, the update processing to make the contents of the secondary volume identical to those of the primary volume is stopped. In short, the performances of the primary volume and the secondary volume do not interfere with each other. The volume concatenation module concatenates a plurality of volumes to create one large-capacity volume.

Here, in the aforementioned volume copy module, the contents between the primary and secondary volumes need not be made identical at the copy pair creating time. In the Pair status, however, before the writing in the primary volume, only the data of the area to write may be saved in the secondary volume. At this time, the data saved in the secondary volume is overwritten in the primary volume, so that the data of the primary volume can be restored to the status at the instant when the Pair status was started.

The management memory is stored with: a CLPR management table 25100 for recording the configuration information of each CLPR; a volume management table 25200 for holding a corresponding relation between each CLPR area and an allocated disk volume; a copy pair management table 25300 for holding management information on the volume copy module in the storage apparatus; and a volume concatenation management table 25400 for holding the management information on the volume concatenation module in the storage apparatus.

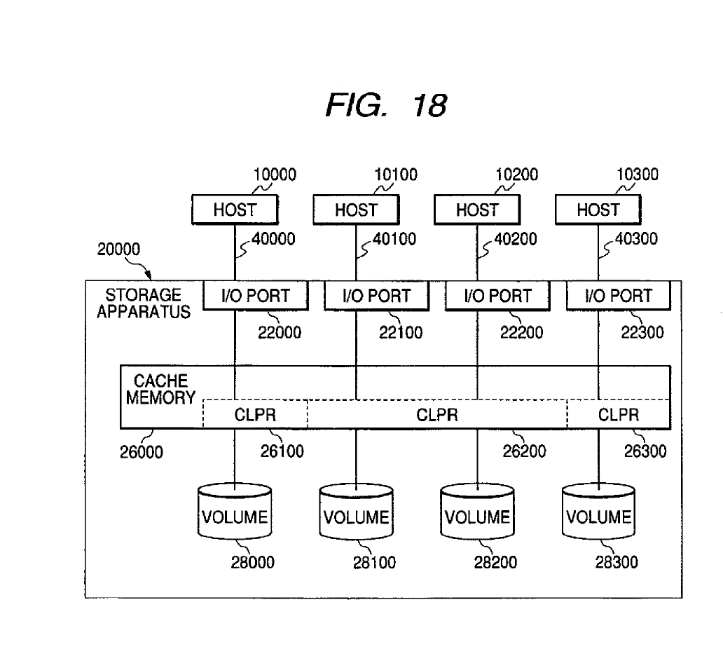

FIG. 18 shows an example of the volumes, the CLPRs and the hosts. Shown are hosts 10000, 10100, 10200, 10300 respectively connected via connections 40000, 40100, 40200, 40300 to I/O ports 22000, 22100, 22200, 22300 of storage apparatus 20000. The cache memory 26000 in the storage apparatus 20000 is logically divided into a plurality of CLPRs 26100, 26200, 26300. The volumes 28000, 28100, 28200, 28300 are connectable from the I/O ports 22000, 22100, 22200, 22300, respectively, via the storage network connections 40000, 40100, 40200, 40300 with the hosts 10000, 10100, 10200, 10300, respectively, for example. When each volume is read/written from the host, one CLPR area designated by the system administrator is used as the cache memory. At this time, one CLPR area can be shared by one or more volumes, as in the case of CLPR area 26200, for example.

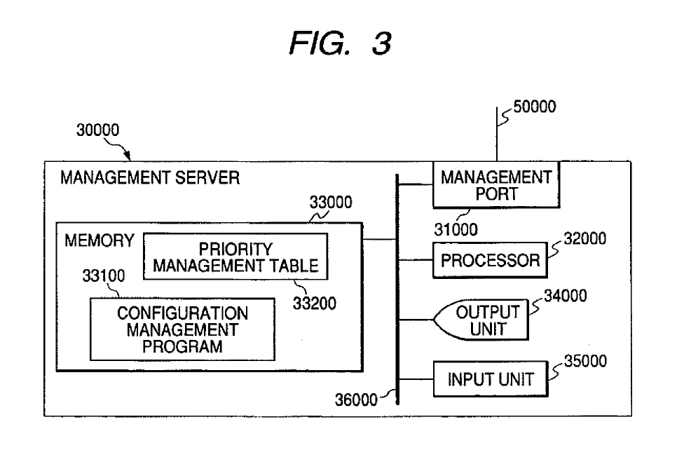

FIG. 3 shows the detailed configuration of a management server 30000. This management server 30000 is composed of: a management port 31000 for connections with the management network 50000; a processor 32000; a memory 33000; a display unit 34000, such as a display device for outputting later-described processed results; and an input unit 35000, such as a key board, for use by the storage administrator to input commands. These components are connected with each other through a circuit 36000, such as an internal bus. The memory 33000 stores a configuration management program 33100 for acquiring the configuration information from the storage apparatus and displaying it to the storage administrator and for executing the configuration information changing command, received from the system administrator, to the storage apparatus.

The memory 33000 also stores a Priority management table, which will be described in connection with Embodiment 2.

FIG. 4 shows the configuration of the CLPR management table 25100 in the storage apparatus 20000. The CLPR management table 25100 is composed of: a field 25110 for registering a CLPR ID or an identifier of each CLPR area in the storage apparatus; a field 25120 for registering the capacity allocated to each CLPR area; and a field 25130 for registering the cache memory address number allocated to each CLPR. The cache memory 26000 of the storage apparatus is divided into fixed blocks, which are individually given address numbers.

FIG. 4 shows one example of specific values of the CLPR management table provided in the storage apparatus. Specifically, FIG. 4 shows that the storage apparatus holds the CLPRs indicated by the CLPR Ids, such as areas CLPR1, CLPR2 and CLPR3, and that each CLPR area holds data block numbers proportional to individual cache capacities. Each CLPR area holds the data block number proportional to the cache capacity specified in the CLPR management table so that it can use a predetermined area of the cache memory.

In response to a changing command received from the system administrator through the input unit, the configuration management program is able to change the configuration of the CLPR areas. This changing command can be ordered to effect any of three methods. One method reduces the cache capacity of a CLPR area, and the reduced capacity is given to another CLPR area. Another method halves a CLPR area. Still another method integrates two CLPRs into one. At this time, the system administrator designates an object CLPR ID and a cache capacity to be increased/decreased. In response to the changing commands described above, the management program 25000 changes the address number to be designated to each CLPR area.

FIG. 5 shows the configuration of the volume management table 25200 owned by the storage apparatus 20000. The volume management table 25200 is composed of: a field 25210 for registering the volume ID or the identifier for each volume in the storage apparatus; and a field 25220 for registering the CLPR ID allocated to each volume.

FIG. 5 shows one example of the specific values of the volume management table provided in the storage apparatus. Specifically, it is shown in FIG. 5 that the VOL1, VOL2 and VOL3, and VOL4 use the area CLPR1, the area CLPR2 and area CLPR3, respectively, as cache memories at the data transferring time.

For example, CLPR1 is an area for holding the data corresponding to a read request or a write request from the computer to the VOL1. In case the VOL1 and the VOL2 are in a copy relation, on the other hand, the volume copy module creates a copy pair composed of the VOL1 (or the primary volume) and the VOL2 (or the secondary volume), and holds the necessary data for coincidence between the primary and secondary contents in the areas CLPR1 and CLPR2. In the first case in which the copy pair is to be created, the data to be stored in the VOL1 is held in the area CLPR1, and the processor writes the data from the area CLPR1 to the area CLPR2, and further from the area CLPR2 to the VOL2. In the updating case, moreover, the processor holds the data, if written in the VOL1, in the area CLPR1, and writes the data from the area CLPR1 to the area CLPR2, and further from the area CLPR2 to the VOL2.

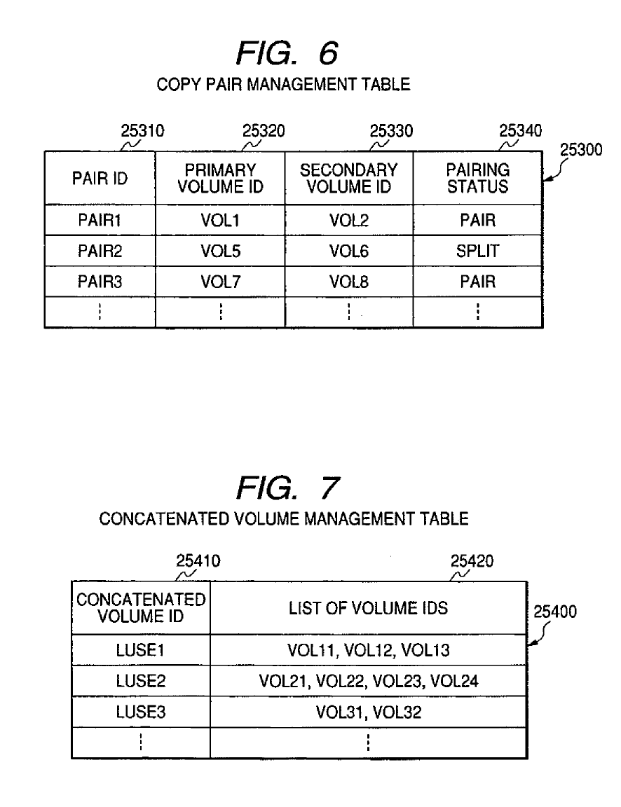

FIG. 6 shows the configuration of the copy pair management table 25300 provided in the storage apparatus 20000. The copy pair management table 25300 is composed of: a field 25310 for registering pair IDs or identifiers of the volume copy pairs in the storage apparatus; field 25320 for registering the volume IDs indicating the primary volumes or copy sources; field 25330 for registering the volume IDs indicating the secondary volumes or copy objects; and field 25340 for acquiring the statuses of the copy pairs from the apparatus and registering the acquired statuses.

FIG. 6 shows one example of the specific values of the copy pair management table provided in the storage apparatus. Specifically, the storage apparatus holds three copy pairs indicated by pair IDs of PAIR1, PAIR2 and PAIR3, and it indicates that the PAIR1 and the PAIR3 are in a status synchronizing the contents of the primary and secondary volumes, and that the PAIR2 stops the updating of the secondary volume temporarily.

FIG. 7 shows the configuration of the concatenated volume management table 25400 provided in the storage apparatus 20000. The concatenated volume management table 25400 is composed of: a field 25410 for registering the concatenated volume ID or an identifier of the concatenated volume in the storage apparatus; and a field 25420 indicating a list of volume IDs or the elements of the concatenated volume.

FIG. 7 shows one example of the specific values of the concatenated volume management table provided in the storage apparatus. Specifically, FIG. 7 shows that the storage apparatus holds three concatenated volumes indicated by the concatenated volume IDs of LUSE1, LUSE2 and LUSE3.

### (2) Procedure of Volume Copy Pair Creation

The volume copy pair creating routine, which is executed by the configuration management program 33100 provided in the management server 30000, will be described. Unless otherwise specified, at each step of the routine, the configuration management program 33100 provided in the memory 33000 is read and executed by the processor 32000.

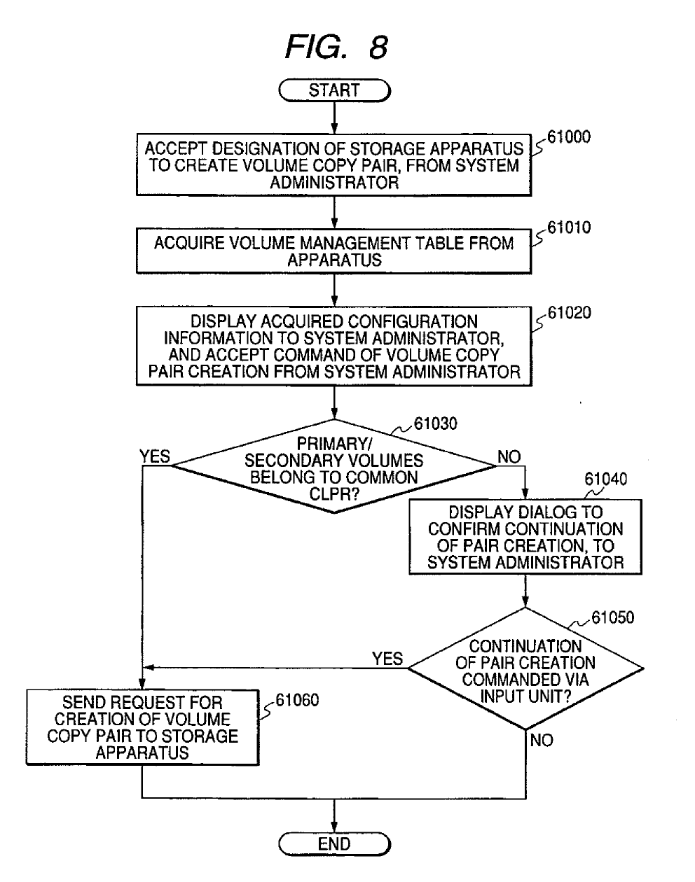

FIG. 8 is a flow chart showing the volume copy pair creating routine.

At first, the configuration management program 33100 accepts (at Step 61000) the designation of the storage apparatus, for creating a volume copy pair, from the system administrator through the input unit 35000. Next, the configuration information is acquired (at Step 61010) from the storage apparatus that has been designated. Specifically, the configuration management program sends a command requesting the transmission of the volume management table 25200, via the management port 31000 of the management server 30000 and the management network 50000, to the management port 21000 provided in the IP address of the storage apparatus 20000 designated by the system administrator.

When the management program 25000 of the storage apparatus receives the transmission request via the management port 21000, the management program 25000 reads the volume management table 25200 from the management memory 24000 and sends the management table to the management server.

The configuration management program of the management server stores, in the memory 33000 of the management server, the volume management table 25200 that has been received. A detailed description of similar specific communication procedures is omitted in the following.

Next, the configuration management program 33100 displays a list of the volume Ids, recorded in the acquired volume management table, to the system administrator using the output unit 34000 of the management server. The system administrator confirms (at Step 61020) the display and inputs the IDs of the primary and secondary volumes, for creating the volume copy pair, through the input unit 35000 of the management server.

When the configuration management program 33100 accepts the volume copy pair creating command from the system administrator, the management program 33100 confirms (at Step 61030), with reference to the volume management table 25200, whether or not the CLPRs, to which the volume designated as the pair belongs, are identical.

In case the confirmation of Step 61030 results in a determination that the primary and secondary volumes belong to an identical CLPR area, the configuration management program 33100 sends (at Step 61060) a request for creating a volume copy pair containing the two volume IDs designated by the system administrator, to the storage apparatus, and ends the volume copy pair creating routine.

In case it is found that the primary and secondary volumes belong to different CLPRs at Step 61030, a message for confirming whether or not the pair creation is to be continued is outputted (at Step 61040) to the system administrator.

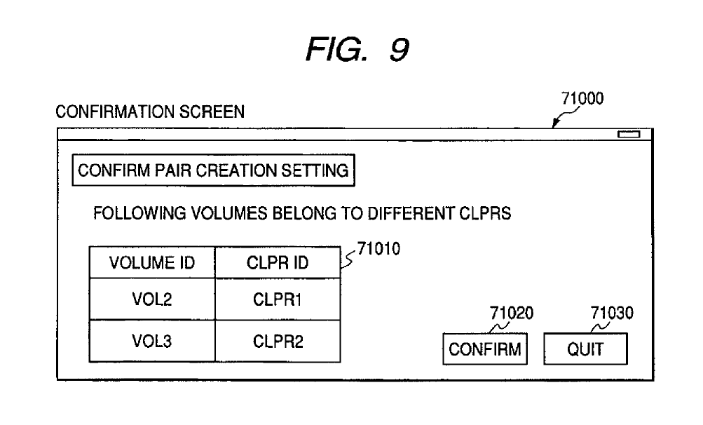

FIG. 9 shows an example 71000 of the volume copy pair creation confirming screen, which is displayed at Step 61040 to the system administrator. In the volume copy pair creation confirming screen 71000, there are displayed, as a list (in Table 71010), the volume IDs which are designated at the time of volume copy pair creation, and the CLPR IDs to which the individual volumes belong, so that the system administrator can recognize that the individual volumes belong to different CLPRs. The system administrator confirms the displayed contents and depresses a “confirmation” button 71020, in case the copy pair creation is to be continued, and a “quit” button 71030 in the case of quitting. This screen 71000 makes it possible to prevent the system administrator from creating a volume copy pair erroneously over the CLPRs.

If the display of Step 61040 results in a command (at Step 61050) to continue the volume copy pair creation as received from the system administrator, a request for creating the volume copy pair containing the two volume IDs designated by the system administrator is sent (at Step 61060) to the storage apparatus. This storage apparatus creates the copy pair, as requested from the configuration management program, and writes the IDs of the primary and secondary volumes and the pair ID given for the discrimination by the apparatus, in the copy pair management table 25300. Then, the storage apparatus sends the copy pair creation ending notification to the configuration management program. The configuration management program 33100 acquires again the copy pair management table when it receives the copy pair creation ending notification. If it is confirmed that the pair is created, as commanded, the volume copy pair creation is ended. If a quitting of the copy pair creation is requested from the system administrator, the volume copy pair creation is ended without sending the volume copy pair creating command to the storage apparatus.

### (3) Procedure of Concatenated Volume Creation

The concatenated volume creating routine, to be executed by the configuration management program 33100, will be described.

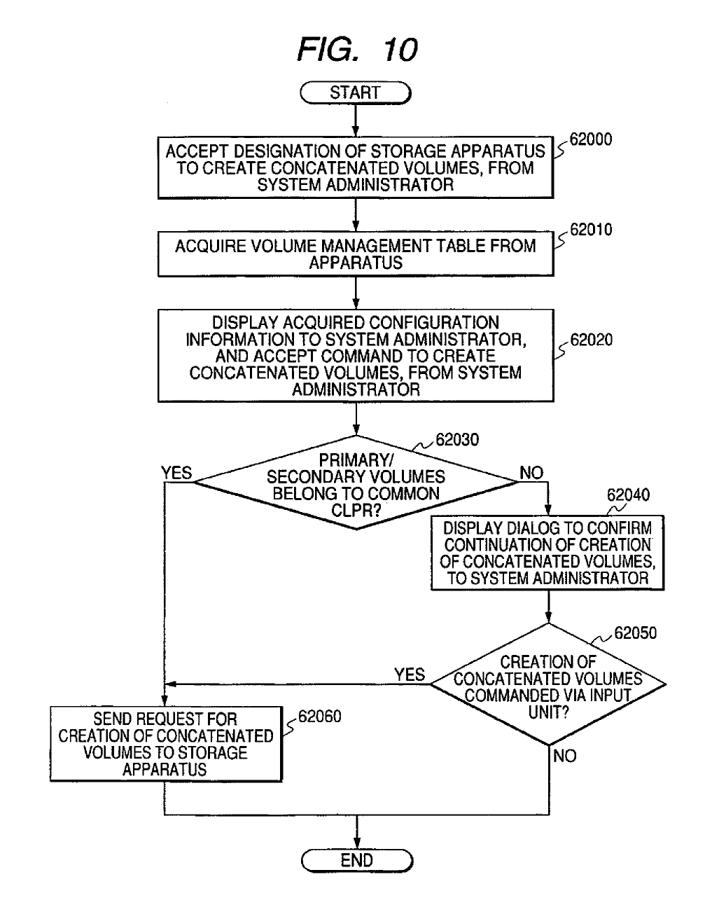

FIG. 10 shows a flow chart of the concatenated volume creating routine.

At first, the configuration management program 33100 accepts (at Step 62000) the designation of the storage apparatus to create the concatenated volume from the system administrator through the input unit 35000. Next, the management program 33100 acquires (at Step 62010) the volume management table 25200 from the designated storage apparatus. Next, the configuration management program 33100 displays, to the system administrator, a list of the volume IDs recorded in the volume management table that has been acquired, using the output unit 34000 of the management server. The system administrator confirms (at Step 62020) the display and inputs the concatenated volume creating command from the input unit 35000 of the management server to the configuration management program.

The configuration management program 33100 refers to the volume management table 25200, when it receives the concatenated volume creating command from the system administrator, and confirms (at Step 62030) whether or not all of the CLPRs, to which the volumes designated as the object of the concatenated volume belong, are identical.

In case the confirmation of Step 62030 reveals that all the concatenated volumes belong to an identical CLPR, the configuration management program 33100 sends (at Step 62060) a request, for creating the concatenated volumes containing the volume IDs designated by the system administrator, to the storage apparatus, and ends the concatenated volume creating routine.

In case it is determined that the volumes to be concatenated belong to different CLPRs at Step 62030, a message for confirming whether or not the concatenated volume creation is to be continued is outputted (at Step 62040) to the system administrator. The message to be outputted at this time is identical to the contents of the volume copy pair creation confirming screen 71000 shown in FIG. 9, except that the apparent display is changed from the “pair creation setting confirmation” to the “concatenated volume creation confirmation”, and that the volume designated as the concatenation object is displayed in place of the primary and secondary volumes. Hence, the outputted message is omitted.

If the display of Step 62040 results in a command (at Step 62050) from the system administrator to continue the concatenated volume creation, a request for creating the concatenated volume containing the volume ID designated by the system administrator is sent (at Step 62060) to the storage apparatus. This storage apparatus creates the concatenated volume, as requested from the configuration management program, and writes the IDs of the volumes to be concatenated and the concatenated volume ID given for the discrimination by the apparatus in the concatenated volume management table 25400. Then, the storage apparatus sends the concatenated volume creation ending notification to the configuration management program. The configuration management program 33100 once again acquires again the concatenated volume management table when it receives the concatenated volume creation ending notification. If it is confirmed that the pair is created, as commanded, the concatenated volume creation is ended. If quitting the concatenated volume creation is requested from the system administrator, the concatenated volume creation is ended without sending the concatenated volume creating command to the storage apparatus.

What has been described is the concatenated volume creation confirming routine.

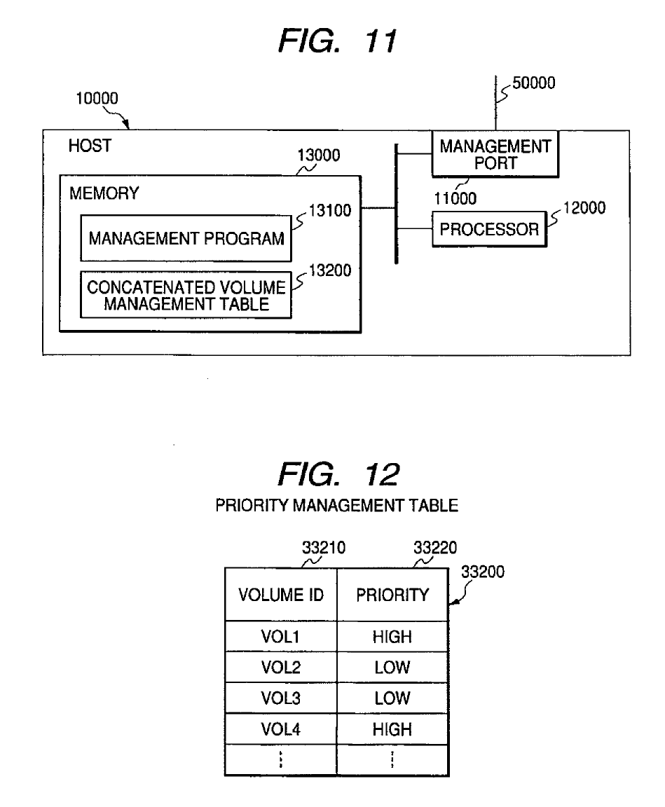

Here, it has been assumed that the management program 25000 concatenates the volumes, and that the concatenated volume management table 25400 is also provided in the storage apparatus. As shown in FIG. 11, however, it is possible to adopt a configuration in which a memory 13000 in the host 10000 has a management program 13100 and a concatenated volume management table 13200 thereover, and in which the management program 13100 performs the volume concatenation. In this modification, the processed contents are identical to those of the aforementioned embodiment, except that the acquirement source of the concatenated volume management table and the transmission object of the concatenated volume creation request are changed from the storage apparatus 20000 to the host 10000.

According to this embodiment, as has been described hereinbefore, when the storage administrator creates the volume copy pairs or the concatenated volume, the configuration management program 33100 can detect a configuration, which might otherwise result in a deteriorated performance independence, and to notify the storage administrator of the detected configuration before it is changed. The storage administrator can confirm the influences to be exerted on the performance independence by the designated configuration and can avoid a configuration change which might otherwise cause a performance interference between businesses.

### Embodiment 2

In Embodiment 2, the configuration management program 33100 changes the CLPR configuration, so that the performance independence of the volumes may be maintained after operation when the storage administrator creates a volume copy pair across different CLPRs. When a volume copy pair is deleted, on the other hand, the CLPR configuration is changed on the basis of the performance independence requested for the primary volume and the secondary volume.

### (1) System Configuration

The configuration of the computer system in Embodiment 2 will be described. The configuration of Embodiment 2 is identical to that of Embodiment 1, except for the fact that a Priority management table 33200 shown in FIG. 12 is added to the memory 33000 of the management server 30000 shown in FIG. 1. Therefore, the portion that is different from that of Embodiment 1 will be described.

FIG. 12 shows the configuration of the Priority management table 33200. This Priority management table 33200 is composed of: a field 33210 for registering in the storage apparatus the volume ID acting as a unique identifier of each volume; and a field 33220 for registering the “Priority” given to each volume by the system administrator.

The “Priority” of the volume is an index indicating the independence of the performance requested for that volume, and it takes one of the two values “High” and “Low”. On the basis of the Priority, the storage administrator administers the necessary management, considering the performance independence of the volume. For example, the volume for storing the data of a business needing a short disk access response time is designated as High, and the storage administrator operates so that the performance of the access to the volume may not be interfered with from access to another volume. On the other hand, the volume needing no performance independence, such as a temporary working folder, is designated as Low. The Priority is given by the administrator at the volume creating time and can be freely changed by the administrator even after the volume has been created.

FIG. 12 shows one example of the specific values of the Priority management table provided in the management server. Specifically, it shows that the administrator desires the performance independence for the VOL1 and the VOL4, but recognizes no necessity for performance independence for the VOL2 and VOL3.

### (2) Procedure of Volume Copy Pair Creation

The volume copy pair creating routine to be executed by the configuration management program 33100 will be described.

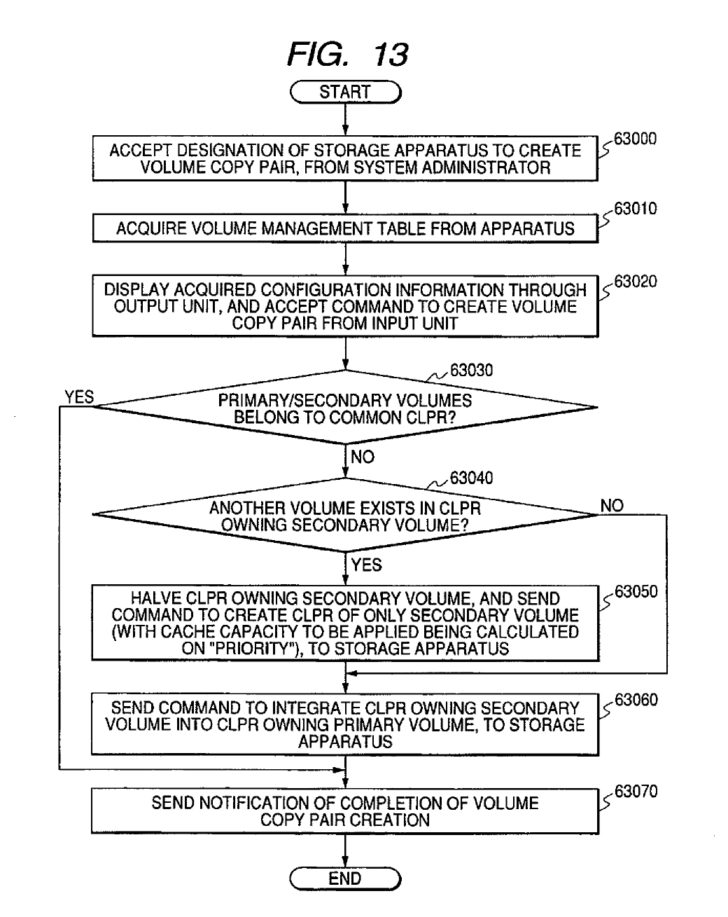

FIG. 13 shows a flow chart of the volume copy pair creating routine. The operations from Step 63000 to Step 63030 are similar to those (from Step 61000 to Step 61030 of FIG. 8) of the Embodiment 1, so that a further description thereof is omitted.

In case the confirmation of Step 63030 results in a determination that the primary and secondary volumes belong to an identical CLPR, the configuration management program 33100 sends (at Step 63070) the request for creating the volume copy pair containing the two volume IDs designated by the system administrator, to the storage apparatus, and ends the volume copy pair creating routine.

In case the primary and secondary volumes belong to different CLPRs, it is determined (at Step 63040) whether or not a volume other than the secondary volume belongs to the CLPR area assigned to the secondary volume. In case no volume other than the secondary volume is allocated to the CLPR area, the routine advances to Step 63060 without dividing the CLPR area. In case a volume other than the secondary volume belongs to the common CLPR, the CLPR owning the secondary volume is halved, and a new CLPR area is created (at Step 63050) to be allocated to only the secondary volume.

At Step 63050, more specifically, the configuration management program 33100 sends the CLPR dividing instruction containing the ID of the original CLPR, to which the secondary volume belongs, and the capacity to be sliced, to the storage apparatus. In response to a request from the configuration management program 33100, the storage apparatus divides the CLPR area, and performs addition to a list of the ID, capacity and address number of the CLPR area newly created, and updates a list of the CLPR capacity and the address number of the division source in the CLPR management table 25100, and updates the CLPR ID of the secondary volume in the volume management table 25200.

The cache memory to be used by the secondary volume is divided from the original CLPR area by forming the new CLPR area, so that the secondary volume can be prevented from interfering in the performance with another volume using that CLPR area.

At Step 63050, the configuration management program 33100 calculates the capacity of the new CLPR area to be sliced from the original CLPR area, on the basis of the Priority of the volume belonging to the original CLPR area. Supposing that data of an important business required for a high performance is stored in the volume needing performance independence, the cache memory is allocated to the individual volumes, namely, at the ratio of 2:1 to the volumes of High and Low Priorities. In case two volumes of High Priority and six volumes of Low Priority are in the CLPR area to which the secondary volume belongs, for example, 2/10 of the total CLPR capacity is allocated to the new CLPR area when the Priority of the secondary volume is High, and 1/10 of the total CLPR capacity is allocated to the new CLPR area when the Priority of the secondary volume is Low. The ID of the new CLPR area that is created is obtained by acquiring the CLPR management table again at Step 63060.

At the next Step 63060, the command to integrate the CLPR area of the sliced secondary volume into the CLPR area of the primary volume is sent together with the ID of the two CLPRs to be integrated, to the storage apparatus. The cache memory quantities to be allocated to the primary and secondary volumes are not fixed, but the two volumes share one CLPR area so that the shortage of the cache memory capacity of one volume can be prevented from bottlenecking the data writing performance.

The storage apparatus integrates the CLPR area, as requested from the configuration management program, and performs a deletion from the list of IDs, capacities and address numbers of the CLPRs, causing this information to disappear as a result of the integration, and an update of the list consisting of the capacity and address number of the CLPR area of the integration object in the CLPR management table 25100, and an update of the CLPR ID of the secondary volume in the volume management table 25200.

After this, the request for creating the volume copy pair containing the two volume IDs designated by the system administrator is sent (at Step 63070) to the storage apparatus.

The storage apparatus creates the copy pair, as requested from the configuration management program, and writes the IDs of the primary and secondary volumes and the pair IDs given for discrimination by the storage apparatus in the copy pair management table 25300. Then, the storage apparatus sends a notification of the end of the copy pair creation process to the configuration management program.

In response to the notification of the end of the copy pair creation process, the configuration management program acquires the copy pair management table again. When it is confirmed that the pair has been created, as commanded, the volume copy pair creation process is ended.

What has been described above is the volume copy pair creating routine.

### (3) Procedure of Volume Copy Pair Deletion

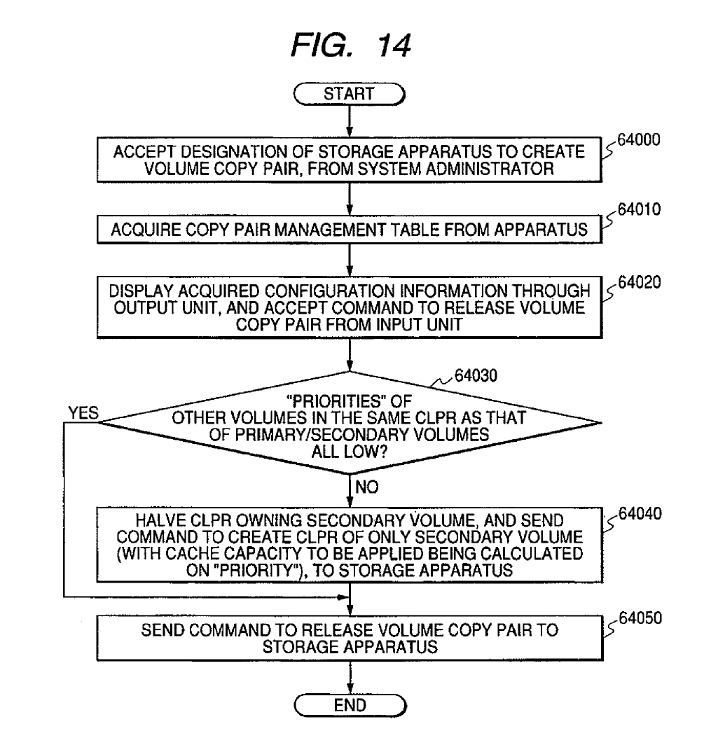

When the volume copy pair is deleted, access from the host computer also occurs to the secondary volume so that it may interferes with the performance of another volume that is sharing the CLPR area. In order to maintain the performance independence, therefore, it is necessary to review the configuration of the CLPR area. Here, the deletion of the volume copy pair involves not only the complete elimination of the pair, but also a change of the pairing status from Pair to Split. FIG. 14 shows a flow chart of the volume copy pair releasing routine. The operations from Step 64000 to Step 64020 are similar to those (from Step 61000 to Step 61020 of FIG. 8) of Embodiment 1, so that their description is omitted.

When the pair ID to delete the volume copy pair is designated (at Step 64020) from the system administrator through the input unit, the configuration management program 33100 examines (at Step 64030) the “Priorities” of all volumes in the CLPRs, to which the primary and secondary volumes belong, with reference to the volume management table 25200. If all of the Priorities of all volumes in the CLPR, including the primary and secondary volumes, are Low at Step 64030, the configuration of the CLPR need not be reviewed to maintain the performance independence, but the request to delete the copy pair designated by the system administrator is sent (at Step 64050) without changing the configuration of the CLPR to the storage apparatus, thereby ending the volume copy pair releasing routine.

If a volume having a High Priority is in the CLPR area, on the other hand, the CLPR area of the secondary volume has to be divided so that the access to the secondary volume after the copy pair deletion may not interfere with the performance of that volume. In case the volume having the High Priority is only the secondary volume, on the other hand, the CLPR area has to be divided so as to provide the secondary volume with a performance independence of access.

Therefore, the configuration management program 33100 halves (at Step 64040) the CLPR area for the secondary volume, and sends a command, to create a new CLPR area to be allocated to the secondary volume, to the storage apparatus. The configuration management program 33100 calculates the cache memory capacity to be allocated to the secondary volume by a method like that used at the aforementioned volume copy pair creating time. The command at Step 64040 contains the ID of the original CLPR area, to which the secondary volume belongs, and the capacity to be sliced.

The storage apparatus divides the CLPR area, as commanded from the configuration management program, and performs an addition, to the list, of the ID, capacity and address number of the CLPR newly created, an update of the list of the capacity and address number of the CLPRs being divided, in the CLPR management table 25100, and an update of the CLPR ID of the secondary volume, in the volume management table 25200.

After this, the request for releasing the copy pair, including the pair ID designated by the system administrator, is sent (at Step 64050) to the storage apparatus.

The storage apparatus deletes the copy pair, as requested from the configuration management program, and deletes the pair having the designated pair ID from the copy pair management table 25300. The storage apparatus sends the copy pair releasing ending notification to the configuration management program. This configuration management program 33100 acquires the copy pair management table again when it receives the copy pair deletion ending notification. When it is confirmed that the pair is deleted, as commanded, the volume copy pair releasing routine is ended.

Here, the definition and expression of the word “Priority” and its capacity calculating method at the time of a CLPR area division according to this embodiment are no more than one example. The Priority need not be singular, but may also be composed of a plurality of parameters. Moreover, the Priority may also have a finer resolution, and it is then expected that a finer cache memory capacity can be calculated.

Moreover, the procedure of creating the volume copy pair according to this embodiment realizes the creation (i.e., Step 63040) of the CLPR area of the secondary volume and the integration (i.e., Step 63050) of the CLPR area of the primary and secondary volumes by commanding the storage apparatus twice. However, the capacity designated with one CLPR area by one command may also be allocated to another CLPR area. In this case, the configuration management program issues commands to allocate the capacity again at Step 63040 and to allocate the secondary volume to the same CLPR area as that of the primary volume at Step 63050.

According to this embodiment, as has been described hereinbefore, the performance independence of the volume by the cache division can be maintained even after the creation and deletion of the volume copy pair has been executed.

### Embodiment 3

In Embodiment 3, the configuration management program presents a choice of the configuration of the Priority and the CLPR area of the volume to be concatenated, and provides a device for the storage administrator to designate, when the storage administrator creates the concatenated volume, the different CLPRs.

### (1) System Configuration

The configuration of the computer system in Embodiment 3 is identical to that of Embodiment 2 so that its further description is omitted.

### (2) Procedure of Concatenated Volume Creation

The concatenated volume creating routine to be executed by the configuration management program 33100 provided in the management server 30000 in Embodiment 3 will be discussed.

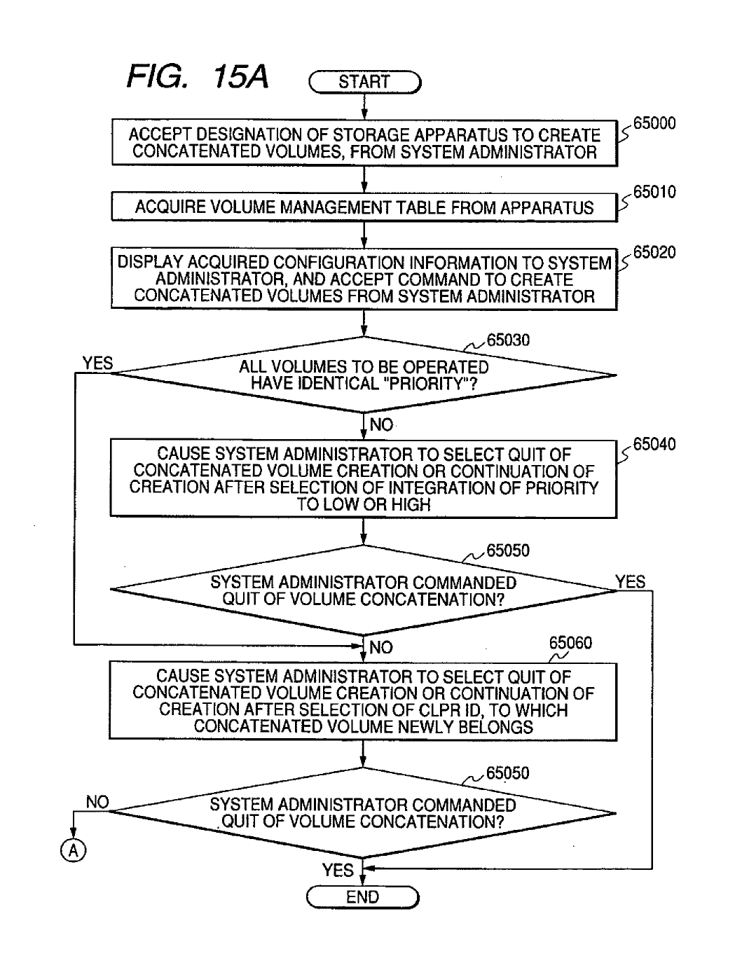

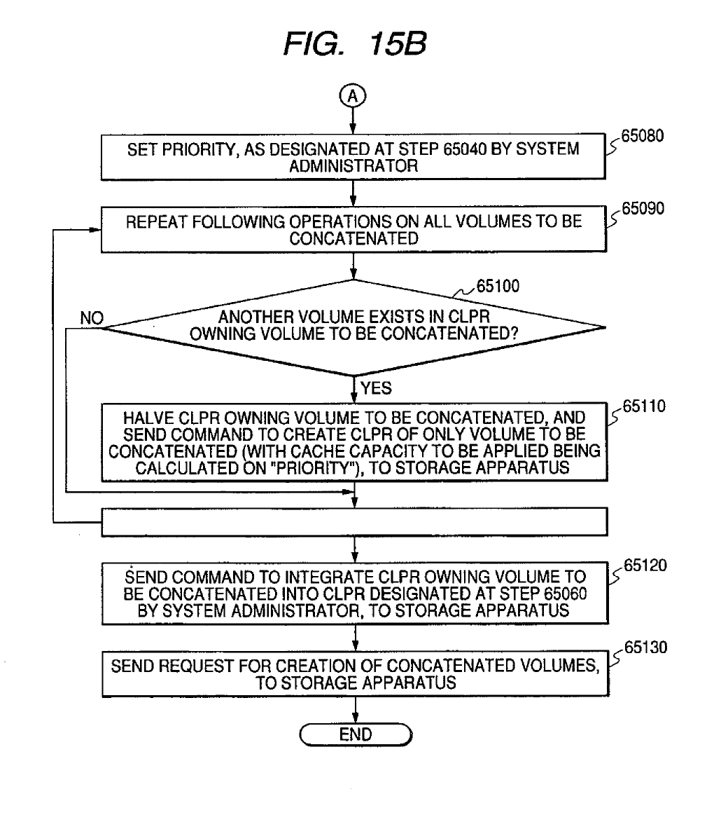

FIG. 15A shows a flow chart of the concatenated volume creating routine. The operations from Step 65000 to Step 65020 are similar to those (from Step 61000 to Step 61020 of FIG. 8) of Embodiment 1, so that a further description thereof is omitted.

When the processor 32000 accepts a command to create a concatenated volume from the system administrator inputted through the input unit, the configuration management program 33100 confirms (at Step 65030) the Priority of the volume designated as the object of the concatenated volume with reference to the volume management table. In case it is found that all of the volumes to be concatenated have an identical Priority as a result of this confirmation, the operation is continued without displaying the Priority setting change screen, and the routine advances to Step 65060.

In case the volume to be concatenated has different Priorities, the operation screen is outputted (at Step 65040) to the system administrator so that the Priority may be unified into the High or the Low priorities to give one Priority to the concatenated volume.

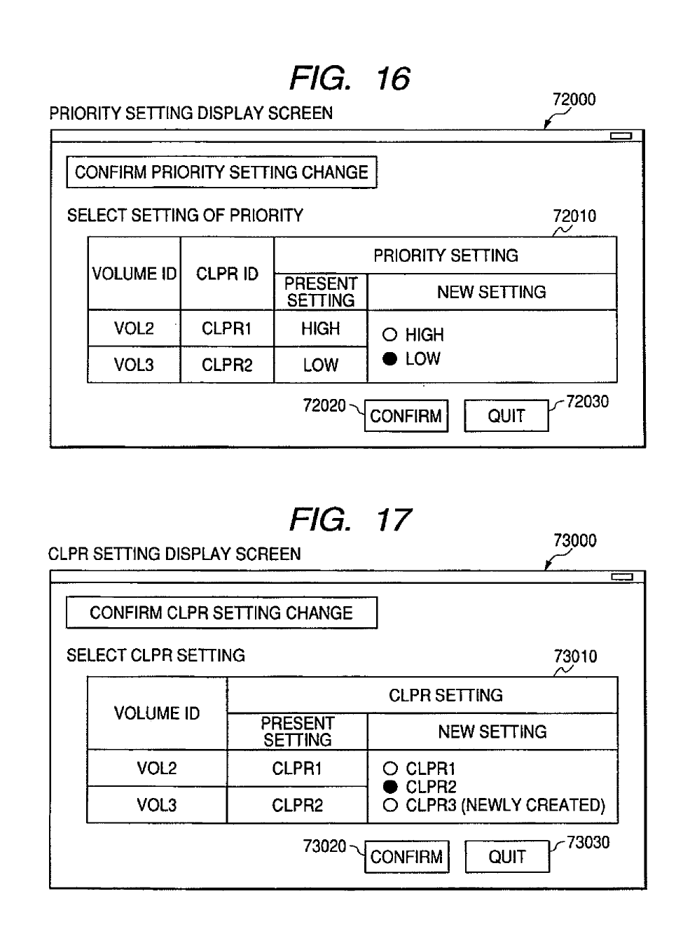

FIG. 16 shows an example 72000 of the Priority setting confirmation screen displayed at Step 65040 in the output unit 34000 to the system administrator. In the Priority setting confirmation screen 72000, the ID of the volume designated by the system administrator at the time of forming the concatenated volume, the CLPR ID to which each volume belongs, and the preset setting situation of the Priority are displayed (in a table 72010) in a list table, so that the Priority of the concatenated volume may be selected by the system administrator. The system administrator confirms the display contents and selects on the screen how the Priority is to be set. The system administrator depresses a “CONFIRM” button 72020 in case the concatenated volume creation is to be continued, but a “QUIT” button 72030 is depressed in case the concatenated volume creation is to be ended.

Returning to FIG. 15A, at Step 65040, when the “QUIT” button is depressed (at Step 65050), the configuration management program ends the routine without commanding the creation of the concatenated volume.

When the “CONFIRM” button 72020 is depressed, on the contrary, the configuration management program stores the Priority changing command received from the user, and the routine advances to Step 65060.

At Step 65060, the operation screen is outputted to the system administrator so that all of the volumes to be concatenated may belong independently to the new CLPR area for the concatenated volume or the CLPR area, to which the volume to be concatenated has belonged.

FIG. 17 shows an example 73000 of the CLPR attribute confirmation screen displayed to the system administrator. This CLPR attribute confirmation screen 73000 displays (in Table 73010) the volume IDs designated as the concatenation object by the system administrator and the CLPR IDs to which the individual volumes belong, so that the system administrator may select how the CLPR is to be newly configured.

Returning to FIG. 15A, at Step 65060, the system administrator will select whether the concatenated volume is independently made to belong to a new CLPR area or to be integrated into any of the CLPRs that the volume to be concatenated intrinsically belongs to.

Confirming the display contents on the display screen of FIG. 17, the system administrator selects on the screen how to set the CLPR and, and depresses a “CONFIRM” button 73020 at the input unit in case the concatenated volume creation is to be continued, while a “QUIT” button 73030 is depressed in case the concatenated volume creation is to be ended.

When the “QUIT” button is depressed (at Step 65070), the configuration management program ends the routine without creating the concatenated volume. When the “CONFIRM” button is depressed, the configuration management program stores the CLPR changing command received from the user, and the routine advances to Step 65080.

The routine advances to FIG. 15B, and the configuration management program rewrites (at Step 65080) the Priority of the volume to be concatenated, as recorded in the Priority management table 33210, according to the designation at Step 65040.

After the operation on the Priority at Step 65080, the configuration management program notes one of the concatenation object volumes designated, and examines (at Step 65100) whether or not any other than the concatenation object volume belongs to the CLPR area, to which the concatenation object volume belongs.

In case no volume other than the concatenation object volume belongs to the common CLPR area, the configuration management program does not command the division of the CLPR area, as described at Step 65110. In case a volume other than the concatenation object volume belongs to the common CLPR area, the CLPR area, to which the volume belongs, is halved, and the configuration management program sends (at Step 65110) a command to create a new CLPR to be allocated to only the concatenation object volume, to the storage apparatus.

The command of Step 65110 is to send the CLPR dividing command, containing the ID of the original CLPR area, to which the secondary volume belongs and the capacity to be sliced, to the storage apparatus.

In response to the command, the storage apparatus divides the CLPR, as requested by the configuration management program, and performs an addition to a list of the ID, capacity and address number of the newly created CLPR, an update of a list of the capacity and address number of the CLPR area of the division source in the CLPR management table 25100, and an update of the CLPR ID of the concatenation object volume in the volume management table 25200.

Here, the configuration management program calculates, at Step 65110, the capacity of the new CLPR area that has been sliced from the original CLPR area, on the basis of the Priority of the volume, to which the original CLPR area belongs. The calculation method is similar to that of Embodiment 2. The ID of the newly created CLPR area is gained by acquiring the CLPR management table again after the execution of Step 65110.

After the operations thus far described has been repeated (at Step 65090) for all of the volumes to be concatenated, the concatenation object volume is integrated (at Step 65120) into the CLPR area which was selected at Step 65060 by the system administrator. The integration of the CLPRs is realized by sending the CLPR integrating command containing the IDs of all CLPRs to be integrated, and the ID of the integration object CLPR, to the storage apparatus. The storage apparatus integrates the CLPRs, as requested from the configuration management program, and performs a deletion from the list of the ID, the capacity and the address number of the CLPR area that has been integrated, causing this information to disappear, and an update in the list of the capacity and the address number of the CLPR area of the integration object in the CLPR management table 25100, and an update of the CLPR ID of the concatenation object volume in the volume management table 25200.

In the storage apparatus 20000, however, three or more CLPRs also may be integrated either by issuing an integrating command to integrate three or more CLPRs all at once or by repeating integrating commands to integrate two CLPRs into one, plural times.

Finally, a request for creating the concatenated volume containing the volume ID designated by the system administrator is sent (at Step 65130) to the storage apparatus. This storage apparatus creates the concatenated volume, as requested from the configuration management program, and writes the ID of the volume to be concatenated and the concatenated volume ID, given for discrimination by the apparatus, in the concatenated volume management table 25400. Then, the storage apparatus sends the concatenated volume creation ending notification to the configuration management program. The configuration management program acquires again the concatenated volume management table when it receives the concatenated volume creating ending notification. The configuration management program ends the concatenated volume creation when it confirms that the concatenated volume has been created, as commanded.

In the procedure of the concatenated volume creation of this embodiment, moreover, the creation (at Step 65110) of the CLPR area of the concatenation object volume and the integration (at Step 65120) of the CLPR area of the concatenation object volume are realized by two commands to the storage apparatus.

Here, in the storage apparatus, the creation and integration of the CLPR area may be performed by one command, that is, the designated capacity may be re-allocated by one command from one CLPR area to another CLPR area. If this operation is carried out, the configuration management program performs the division of the CLPR area and the integration of the divided CLPRs at Step 65110 in response to the commands to create and integrate the CLPR area through the input unit.

According to this embodiment, as has been described hereinbefore, when a concatenated volume is to be created, the configuration management program can detect a difference in the Priorities of the concatenation object volume and can integrate the Priorities of the concatenated volume. It is also possible to provide a device, in which the configuration management program can present the selected branch of the CLPR configuration to be allocated to the concatenated volume and in which the CLPR configuration after the volume concatenation can be designated by the storage administrator.

In the foregoing various embodiments, moreover, the configuration management program in the management server commands the storage apparatus to perform an integration or further division of the CLPRs considering the relation between the volumes and the CLPRs at the time of creating pairs of volumes. In the storage apparatus, however, the configuration management program may be stored in the memory and may be read and executed by the processor so that the integration/division of the CLPRs may be performed in consideration of the relation between the volumes and the CLPRs. According to the various embodiments, the cache memory can be efficiently allocated to the volumes on the basis of the relation between the volumes. Not depending on the paired relation between the volumes, but also considering the status of the pair, the cache memory can be efficiently distributed among the volumes.

When the storage administrator executes an operation to relate the plural volumes, such as to copy or concatenate the volumes, moreover, it is possible to prevent the performance independence between the businesses from being erroneously deteriorated by the CLPR area configuration.

By designating the priority from the viewpoint of the performance independence in advance for the volumes, moreover, the management program can change the CLPR configuration while maintaining the performance independence between the businesses when the storage administrator executes the creation/deletion of the volume copy pair and the creation of the concatenated volume.

What is claimed is:

1. A management method for a cache memory of a storage apparatus including: at least one volume for storing data to be accessed from a computer via a network; and a cache memory, to which an area for holding the data to be stored in said at least one volume is allocated for every said at least one volume, comprising the steps of:
referring to a relation between predetermined volumes; and
allocating an area, in which the data to be stored in a volume are held, to said volume on the basis of the relation between said volumes.

2. A method for managing a configuration of a storage apparatus including a plurality of volumes useable by a host via a network, and including a cache memory for holding data with respect to the plurality of volumes, where a first volume and a second volume are mutually-different volumes of the plurality of volumes and are candidates to be copy paired to one another as primary and secondary copy volumes, the method comprising:
dividing the cache memory into a plurality of cache areas;
assigning each cache area of the plurality of cache areas to one or more volumes of the plurality of volumes, wherein each volume is assigned to only one cache area;
and in only a situation where the first volume and the second volume are presently assigned to different cache areas from one another, performing the further operations of:
determining whether a respective cache area assigned to the second volume, is co-assigned to a third volume for which there is no pair relationship of the third volume with either of the first volume or the second volume;
and in only a situation where the respective cache area is co-assigned to the second volume and the third volume, performing the further operations of:
dividing any co-assigned respective cache area as found co-assigned by the determining operation, into a divided first sub-cache area for the second volume which is separated out from a divided second sub-cache area for the third volume;
integrating the divided first sub-cache area for the second volume and a respective cache area assigned to the first volume together, to form a single integrated cache area to be shared by the first volume and the second volume; and
requesting the storage apparatus to create a copy pair relationship between the first volume and the second volume as the primary volume and the secondary volume, respectively.

3. The method according to claim 2, comprising:
integrating storage areas of the first volume and the second volume, to form a single integrated cache area to be shared by the first volume and the second volume.

4. The method according to claim 2, comprising:
in preparation to remove the copy pair relationship between the first volume and the second volume, dividing the assigned sub-cache area into a reduced first sub-cache area and a reduced second sub-cache area;
assigning the reduced first sub-cache area to the first volume;
assigning the reduced second sub-cache area to the second volume; and,
removing the copy pair relationship between the first volume and the second volume.

5. A method for managing a configuration of a storage apparatus including a plurality of volumes useable by a host via a network, and including a cache memory for holding data with respect to the plurality of volumes, where a first volume and a second volume are mutually-different volumes of the plurality of volumes and are candidates to be copy paired to one another as primary and secondary copy volumes, the method comprising:
dividing the cache memory into a plurality of cache areas;
assigning each cache area of the plurality of cache areas to one or more volumes of the plurality of volumes, wherein each volume is assigned to only one cache area;
and in only a situation where the first volume and the second volume are presently assigned to different cache areas from one another, performing the further operations of:
determining whether a respective cache area assigned to the second volume, is co-assigned to a third volume for which there is no pair relationship of the third volume with either of the first volume or the second volume;
and in only a situation where the respective cache area is co-assigned to the second volume and the third volume, performing the further operations of:
dividing any co-assigned respective cache area as found co-assigned by the determining operation, into a divided first sub-cache area for the second volume which is separated out from a divided second sub-cache area for the third volume;
integrating the divided first sub-cache area for the second volume and a respective cache area assigned to the first volume together, to form a single integrated cache area to be shared by the first volume and the second volume;
requesting the storage apparatus to create a copy pair relationship between the first volume and the second volume as the primary volume and the secondary volume, respectively; and
integrating storage areas of the first volume and the second volume into an integrated first/second volume, to be handled as a single integrated volume.

6. The method according to claim 5, comprising:
in preparation to remove the copy pair relationship between the first volume and the second volume, dividing the integrated cache area into a reduced first sub-cache area and a reduced second sub-cache area;
assigning the reduced first sub-cache area to the first volume;
assigning the reduced second sub-cache area to the second volume; and,
removing the copy pair relationship between the first volume and the second volume.

7. A system comprising:
a storage apparatus including a plurality of volumes useable by a host via a network, and including a cache memory for holding data with respect to the plurality of volumes, where a first volume and a second volume are mutually-different volumes of the plurality of volumes and are candidates to be copy paired to one another as primary and secondary copy volumes, where the cache memory is divided into a plurality of cache areas, and where each cache area of the plurality of cache areas is assigned to one or more volumes of the plurality of volumes, wherein each volume is assigned to only one cache area;
a determination unit configured to determine whether a respective cache area assigned to the second volume, is co-assigned to a third volume for which there is no pair relationship of the third volume with either of the first volume or the second volume;
a cache dividing unit configured to divide any co-assigned respective cache area as found co-assigned by the determination unit, into a divided first sub-cache area for the second volume which is separated out from a divided second sub-cache area for the third volume; and
a cache integrating unit configured to integrate the divided first sub-cache area for the second volume and a respective cache area assigned to the first volume together, to form a single integrated cache area to be shared by the first volume and the second volume; and
a configuration change unit configured to request the storage apparatus to create a copy pair relationship between the first volume and the second volume as the primary volume and the secondary volume, respectively;
wherein the determination unit, the cache dividing unit, the cache integrating unit and the configuration change unit effect their operations in only a situation where the first volume and the second volume are presently assigned to different cache areas from one another; and
wherein the cache dividing unit, the cache integrating unit and the configuration change unit effect their operations in only a situation where the determination unit determines that the respective cache area is co-assigned to the second volume and the third volume.

8. The system according to claim 7, comprising:
a volume integrating unit configured to integrate storage areas of the first volume and the second volume into an integrated first/second volume, to be handled as a single integrated volume.

9. The system according to claim 7, comprising:
the cache dividing unit configured to divide the assigned sub-cache area, in preparation to remove the copy pair relationship between the first volume and the second volume, into a reduced first sub-cache area and a reduced second sub-cache area;
the cache reassignment unit configured to assign the reduced first sub-cache area to the first volume, and to assign the reduced second sub-cache area to the second volume; and,
a configuration change unit configured to remove the copy pair relationship between the first volume and the second volume.

10. A system comprising:
a storage apparatus including a plurality of volumes useable by a host via a network, and including a cache memory for holding data with respect to the plurality of volumes, where a first volume and a second volume are mutually-different volumes of the plurality of volumes and are candidates to be copy paired to one another as primary and secondary copy volumes, where the cache memory is divided into a plurality of cache areas, and where each cache area of the plurality of cache areas is assigned to one or more volumes of the plurality of volumes, wherein each volume is assigned to only one cache area;
a determination unit configured to determine whether a respective cache area assigned to the second volume, is co-assigned to a third volume for which there is no pair relationship of the third volume with either of the first volume or the second volume;
a cache dividing unit configured to divide any co-assigned respective cache area as found co-assigned by the determination unit, into a divided first sub-cache area for the second volume which is separated out from a divided second sub-cache area for the third volume;
a cache integrating unit configured to integrate the divided first sub-cache area for the second volume and a respective cache area assigned to the first volume together;
a configuration change unit configured to request the storage apparatus to create a copy pair relationship between the first volume and the second volume as the primary volume and the secondary volume, respectively; and
a volume integrating unit configured to integrate storage areas of the first volume and the second volume, to form a single integrated cache area to be shared by the first volume and the second volume;
wherein the determination unit, the cache dividing unit, the cache integrating unit, the configuration change unit and the volume integration unit, effect their operations in only a situation where the first volume and the second volume are presently assigned to different cache areas from one another; and
wherein the cache dividing unit, the cache integrating unit, the configuration change unit and the volume integration unit, effect their operations in only a situation where the determination unit determines that the respective cache area is co-assigned to the second volume and the third volume.

11. The system according to claim 10, comprising:
the cache dividing unit configured to divide the assigned sub-cache area, in preparation to remove the copy pair relationship between the first volume and the second volume, into a reduced first sub-cache area and a reduced second sub-cache area;
the cache reassignment unit configured to assign the reduced first sub-cache area to the first volume, and to assign the reduced second sub-cache area to the second volume; and,
a configuration change unit configured to remove the copy pair relationship between the first volume and the second volume.
